(19) United States
(12) Patent Application Publication
(10) Pub. No.: US 2020/0206544 A1
(43) Pub. Date: Jul. 2, 2020

(54) HOODS, RESPIRATOR HOODS, AND OTHER ARTICLES INCLUDING JOINED THERMOPLASTICS AND ELASTOMERS, AND RELATED METHODS

(71) Applicant: ELMRIDGE PROTECTION PRODUCTS, LLC, Boca Raton, FL (US)

(72) Inventors: Kenneth VAUGHAN, Frederick, MD (US); Christopher G. ESTKOWSKI, Pullman, MI (US)

(21) Appl. No.: 16/237,075

(22) Filed: Dec. 31, 2018

(51) Int. Cl. A62B 18/08; A62B 18/04

(52) U.S. Cl. CPC A62B 18/084; A42B 3/288; A62B 18/04

(57) ABSTRACT

A hood is provided that includes a collar and a head covering. The collar includes at least one elastomeric layer configured to be sealingly fit around a body part of a wearer. The elastomeric layer includes perforations. The head covering includes at least one thermoplastic layer configured to receive a head of the wearer and terminating at an edge portion defining an opening configured for insertion of the head of the wearer. The head covering further includes integral connections extending through the perforations of the elastomeric layer to sealingly engage the head covering to the collar. Also provided are containment assemblies and methods of making and using the same.

### FIELD OF THE INVENTION

This invention relates to hoods, respirator-incorporated hoods, tubular covers, and other articles that include a collar made of an elastomer, such as a natural rubber and/or synthetic rubber, joined to a thermoplastic film or sheet, and to methods of joining such materials together.

### BACKGROUND OF THE INVENTION

There are many methods for joining materials to one another. One such method is to use mechanical fasteners, such as nails, screws, nuts and bolts, braids and the like. Another method involves the controlled application of heat, such as by welding, soldering and brazing. Yet another method involves the application of reactive and non-reactive adhesives, such as glues, epoxies, and cements. Still another method is sewing with a needle and thread. These methods have been researched, developed, and improved upon as the variety of materials available has increased.

Particular problems and difficulties associated with the above-described methods are encountered when applied to join dissimilar materials, particularly dissimilar materials that are difficult to bond together. For example, problems and difficulties may arise when attempting to join an elastomeric material, such as a natural or synthetic rubber, and a flexible material, especially those made of thermoplastic materials such as a polyvinyl chloride, polyethylene or polyurethane. One particular problem is forming a seal at the interface of the thermoplastic and the elastomer.

For example, in the case of sleeves of the type used in the treatment of a wound to a patient's arm or leg, it may be beneficial to shape the sleeve body as a tube with a seal at each end. The sleeve body is shaped to fit around a patient's extremity, such as an arm or leg, in order to cover and protect a wound. The seals at opposite ends of the sleeve body reduce or eliminate the risk of infection. In this application, the sleeve body may be a flexible thermoplastic material such as polyvinyl chloride, polyethylene or polyurethane. The elastomeric seals at the end openings of the sleeve body may be made of natural or synthetic rubber. Each of the elastomeric seals will form an opening so that the patient's arm can be placed through the sleeve and placed into the desired position, while having elasticity to fit tightly around the patient's arm to form a barrier to infection and airborne contaminants.

Another example of an article containing a thermoplastic layer and elastomeric layer joined to one another is a hood of the type that envelops a wearer's head to protect against a harsh environment or an airborne contaminant. A seal located at an opening of the hood to fit around the wearer's neck is designed to reduce the risk of contamination leaking into the hood. The hood is typically made of a flexible thermoplastic material such as polyvinyl chloride, polyethylene or polyurethane. The elastomeric material is made of natural or synthetic rubber, which is flexible to allow the hood to be pulled over the wearer's head and placed into the required position. The elastomeric material has adequate memory to fit tightly around the wearer's neck to form a barrier to airborne contamination.

As mentioned above, a number of methods exist for joining materials.

Mechanical fasteners and fixing devices, such as staples, can join wide varieties of materials together. A disadvantage of using mechanical fasteners includes the danger of damaging the materials being joined together, the risk of the mechanical fasteners becoming loose, the possibility of the mechanical fasteners becoming corroded, and the complexity and cost of the manufacturing processes associated with mechanical fasteners. In addition, when the elastomer is to serve as a seal, the mechanical fasteners may reduce the effectiveness of the seal because the mechanical fasteners introduce holes (a route for the passage of contamination) in the elastomeric material and adversely affect flexing of the elastomer. In addition, mechanical fasteners such as staples may cause injury to the wearer by scratching, abrading, or the like.

Adhesives have proven ineffective in joining elastomer materials directly to thermoplastics such as polyvinyl chloride, polyethylene and polyurethane. Given the current state of the science of adhesives, some very useful combinations of elastomeric materials and plastics cannot be effectively directly bonded with known adhesives. A solution to this problem is the insertion of an intermediate material between the elastomer and thermoplastic material as an assembly agent. The manufacturing process is modified so that the natural or synthetic rubber portion is glued to the assembly agent, and then a thin thermoplastic film or sheet is glued to the assembly agent. Another solution to the problems of adhesive involves the use of a curing agent that attacks the molecular surface of the elastomeric material or the thin thermoplastic film or sheet to form a chemical bond. These solutions are costly and are complex when scaled for manufacturing production. Further, the introduction of adhesives into a manufacturing line involves many processing variables, such as the amount of adhesive applied, the pressure to be applied, the time needed for curing or for setting, the human element, and the evenness of the adhesive over the entire surface. These and other variables must be carefully controlled during manufacturing or the adhesive bond between the materials may be inadequate and will fail. Furthermore, adhesives are known for their off gassing of vapors. Such vapors are potentially toxic and harmful, and can cause illness, irritation, or allergic reactions to those who are exposed to the vapors.

While sewing can be used to join an elastomeric material to a thermoplastic material, sewing includes the risk of damaging the materials being joined together, the risk of the stitches becoming loose, and production costs. In addition, when the purpose of the elastomeric portion is to function as a hermetic seal, stitches may reduce the effectiveness of the seal because the needles used during sewing will introduce holes in the elastomeric material and the flexible thermoplastic material and these holes may provide a route for the passage of contamination.

Thermal bonding and welding, including RF welding and ultrasonic welding, are not effective in joining elastomers directly to thermoplastics. A disadvantage of thermal bonding and ultrasonic welding includes the differing reaction of materials to the application of heat and pressure. Natural rubber and synthetic rubber may be heat treated and vulcanized to bond with certain materials, but not with thermoplastics such as polyvinyl chloride, polyethylene or polyurethane.

### SUMMARY OF THE INVENTION

According to a first aspect of the invention, a hood is provided that includes a collar and a head covering. The collar includes at least one elastomeric layer configured to be sealingly fit around a body part of a wearer. The elastomeric layer includes perforations. The head covering includes at least one thermoplastic layer configured to receive a head of the wearer and terminates at an edge portion defining an opening configured for insertion of the head of the wearer. The head covering further includes integral connections extending through the perforations of the elastomeric layer to sealingly engage the head covering to the collar.

A second aspect of the invention provides a containment assembly including a collar and a covering. The collar includes at least one elastomeric layer configured to be sealingly fit around a body part of a wearer. The elastomeric layer includes perforations. The covering includes at least one thermoplastic layer configured to receive the body part of the wearer and terminating at an edge portion defining an opening configured for insertion of the body part of the wearer. The covering further includes integral connections extending through the perforations of the elastomeric layer to sealingly engage the covering to the collar.

A third aspect of the invention provides a method of joining together at least one thermoplastic layer and at least one elastomeric layer. The method involves providing a plurality of perforations in the at least one elastomeric layer, bringing the at least one thermoplastic layer and the at least one elastomeric layer together, at least partially melting the at least one thermoplastic layer, causing the at least one thermoplastic layer to flow into the perforations of the at least one elastomeric layer, and solidifying the at least one thermoplastic layer with connections integral with the at least one thermoplastic layer extending through the perforations.

Other aspects of the invention, including components, parts, sub-assemblies, assemblies, kits, processes, and the like which constitute part of the invention, will become more apparent upon reading the following detailed description of the exemplary embodiments.

### BRIEF DESCRIPTION OF THE DRAWINGS

The accompanying drawings are incorporated in and constitute a part of the specification. The drawings, together with the general description given above and the detailed description of the exemplary embodiments and methods given below, serve to explain the principles of the invention. In such drawings:

FIGS. 1A through 1D depict consecutive steps of a method for joining elastomeric and thermoplastic layers together according to a first embodiment of the invention;

FIG. 2A through 2E depict consecutive steps of a method for joining elastomeric and thermoplastic layers together according to a second embodiment of the invention;

FIG. 3 is a plan view of an elastomeric material with perforations according to the invention;

FIG. 4 is a perspective view of a thermoplastic protective cover encasing an object with an elastomeric collar at an opening of the covering according to the invention;

FIG. 5 is a perspective view of a thermoplastic protective sleeve with elastomer seals placed onto a human arm according to a further embodiment of the invention;

FIG. 6 is a side view of a thermoplastic hood with a horizontally oriented elastomeric collar according to the invention;

FIG. 7 is a side view of a thermoplastic hood with a vertically oriented elastomeric collar according to another embodiment of the invention;

FIG. 8 is a side view of a thermoplastic hood with an angled elastomeric seal according to another embodiment of the invention;

FIG. 9 is a side view of a hood with respiratory device and an elastomeric neck collar according to still another embodiment of the invention;

FIG. 10 is a side view of a hood with respiratory device and an elastomeric neck collar according to yet another embodiment of the invention;

FIG. 11 is a front see-through view of a hood with a respiratory device and an elastomeric collar according to a further embodiment of the invention;

FIG. 12 is a perspective see-through view of the hood of FIG. 11;

FIG. 13 is a side see-through view of the hood of FIG. 11; and

FIG. 14 is an enlarged, fragmented bottom perspective view of the hood of FIG. 11.

### DETAILED DESCRIPTION OF THE EXEMPLARY EMBODIMENT(S) AND EXEMPLARY METHOD(S)

Reference will now be made in detail to exemplary embodiments and exemplary methods of the invention. It should be noted, however, that the invention in its broader aspects is not necessarily limited to the specific details and steps, representative materials, and illustrative examples shown and described in connection with the exemplary embodiments and exemplary methods.

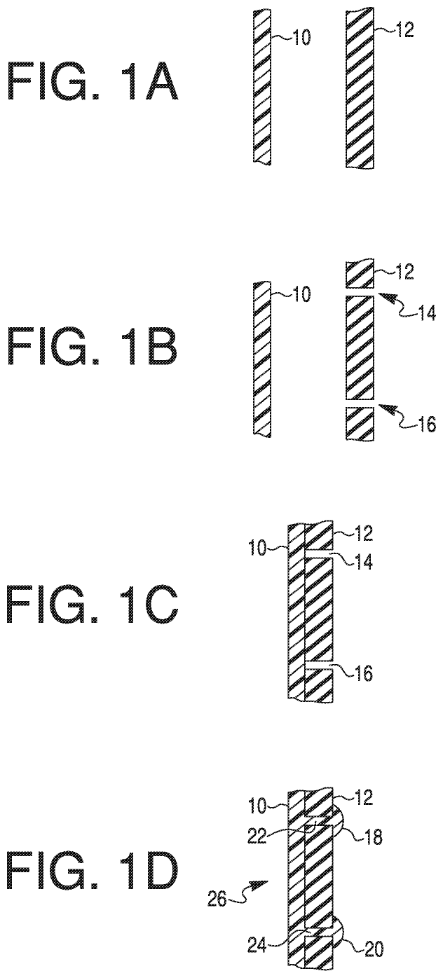

An embodiment of a method and structure of the present invention is illustrated in FIGS. 1A through 1D, which depict the steps involve for joining together an elastomeric sheet material and a flexible sheet material.

FIG. 1A illustrates a cross section of a flexible material embodied as a planar thermoplastic layer or sheet 10. When heated above their melt temperature, thermoplastics soften or melt into a flowable or moldable form, and return to a solid state when cooled. Thermoplastics that may be used for the thermoplastic layer 10 of this embodiment and thermoplastic layers of other embodiments described herein include, for example, polyvinyl chloride (PVC), polyethylene (PE), polypropylene (PE), polyurethane (PU), polycarbonate, polystyrene, polybenzimidazole, acrylics, acrylonitrile-butadiene-styrene (ABS), polyamides (e.g., Nylons), and polytetrafluoroethylene (e.g., Teflon®), and combinations, copolymers, and terpolymers thereof. Different thermoplastics have different melting temperatures and thus involve the use of different process parameters. For example, polypropylene melts at 302° C. (575° F.), ABS melts at 260° C. (500° F.), and PVC melts at 274° C. (525° F.). Some thermoplastics are better suited for being joined by a heat-generating process than others. For example, thermoplastics such as polycarbonate have high melting points and are difficult to join by heat-generating processes. Others such as PE, PP, polyamides, thermoplastic polyesters, acetal, and polyphenylene sulfide tend to melt and re-solidify too quickly, making them difficult to join by heat-generating processes. Thermoplastic polyurethane is well suited for use in flexible products such as hoods and enclosures. While we prefer use of thermoplastic polyurethane, the invention is not so limited.

FIG. 1A also illustrates an elastomeric layer or sheet 12 in cross section. The elastomeric layer 12 may be made of, for example, a natural and/or synthetic rubber, such as silicone rubber, neoprene, or ethylene-propylene-diene monomer (EPDM) rubber, or combinations thereof. The elastomeric layer 12 may have memory to return to its original shape after stretching, and preferably is suitable for forming a seal around a body part.

FIG. 1B depicts in cross section the elastomeric layer 12 provided with multiple perforations 14 and 16. Although two perforations 14 and 16 are shown in FIGS. 1B through 1D, it should be understood that a single perforation may be provided in the elastomeric layer 12. Alternatively, two, three, four, five, or more perforations may be formed in the elastomeric layer 12. The perforations 14 and 16 may be of a constant diameter, as shown, or may taper or may be non-uniform across the thickness of the elastomeric layer 12. The perforations 14 and 16 may have identical or different dimensions and shapes relative to one another. For example, the perforations 14 and 16 may be circular, polygonal, oval, slit-shaped, etc. Formation of the perforations 14 and 16 in the elastomeric layer 12 may be accomplished mechanically using, for example, a flash cut machine. Alternatively, the perforations 14 and 16 may be formed in situ during formation of the elastomeric layer 12 using an appropriate molding technique, such as injection molding.

FIG. 1C is a cross-sectional view of the thermoplastic and elastomeric layers 10 and 12, respectively, abutting one another in direct surface-to-surface contact with no intermediate material interposed between the layers 10 and 12. An external source or sources of heat and pressure (such as mold dies (not shown)) are applied to the layers 10 and 12 for an adequate amount of time to allow the thermoplastic layer 10 to melt and flow into and through the perforations 14 and 16 of the elastomeric layer 12. The temperature preferably is not so high as to degrade the elastomeric material of the elastomeric sheet 12. Suitable temperatures and pressures will depend upon the particular thermoplastic material selected, but the temperatures desirably are at or above the melting temperature of the thermoplastic material.

As best shown in FIG. 1D, the at least partially melted thermoplastic layer 10 flows into and through the perforations 14 and 16 to the opposite side of the elastomeric layer 12 due to the pressure applied in the mold. The thermoplastic material may spread onto the opposite surface of the elastomeric layer 12 and preferably hardens to form heads 18 and 20 having a greater dimension (width or diameter) than the diameter of the perforations 14 and 16. As a result, the heads 18 and 20 cannot pass through the perforations 14 and 16. In FIG. 1D, the heads 18 and 20 have a hemispherical shape, resembling a bulb or dome. It should be understood that the heads 18 and 20 may have other shapes. Elongated portions 22 and 24 of the thermoplastic material extend through the perforations 14 and 16 to integrally connect the thermoplastic layer 10 to the heads 18 and 20, respectively. As can be understood, the melted thermoplastic material flows through the perforations 14, 16 due to the pressure and forms the elongated portions and heads 18, 20 to effectively join the elastomeric layer 12 to the thermoplastic layer 10. The die may have recesses or cavities into which the melted thermoplastic flows to form the heads 18 and 20. The diameter of the recesses or cavities is greater than that of the perforations 14 and 16, so that after the heads 18 and 20 solidify they are too large to pass back through the perforations 14 and 16.

The thermoplastic material is then cooled below its melting temperature so that the heads 18 and 20 interlock the thermoplastic layer 10 to the elastomeric layer 12. The heads 18 and 20 and the interconnecting portions 22 and 24 of the thermoplastic material are formed integrally with the thermoplastic layer 10, such that the thermoplastic layer 10, the heads 18 and 20, and the interconnecting portions 22 and 24 are a single piece (monolithic) with no mechanical fasteners or adhesive required. The pressure source (e.g., mold dies) may be removed prior to, during, or after cooling of the thermoplastic material. Collectively, the thermoplastic and elastomeric layers 10 and 12 form a multi-layer (two-layer in FIG. 1D) composite structure 26. Preferably, the method and structure of the first embodiment of the invention provides extended strength and reliability and overcome some, if not all, of the problems and difficulties of the background art.

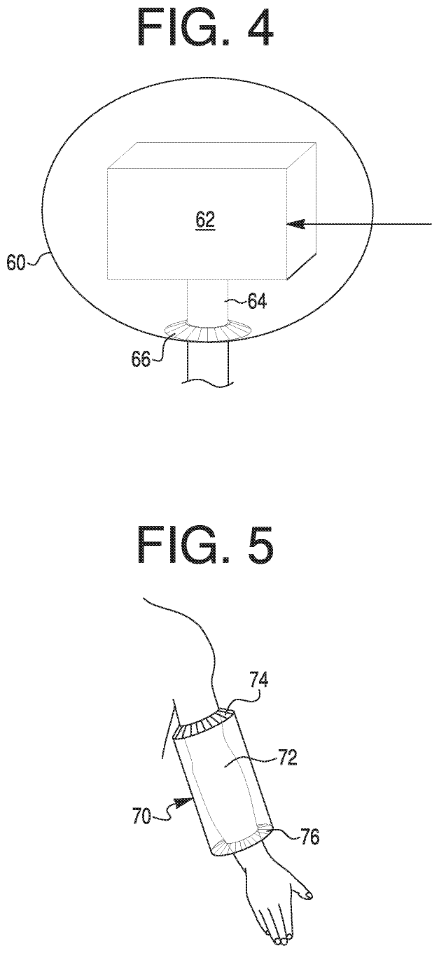

While only single thermoplastic and elastomeric layers 10, 12 are shown in FIGS. 1A through 1D, the multi-layer structure 26 may include two or more thermoplastic layers 10 and/or two or more elastomeric layers 12. For example, the elastomeric layer 12 of FIGS. 1A through 1D can be replaced with two or more adjacent elastomeric layers. Alternatively, the thermoplastic layer 10 can be replaced with two or more thermoplastic layers adjacent to one another. Any one or more of the thermoplastic and elastomeric layers 10 and 12 may be planar, non-planar, uniform in thickness, or non-uniform in thickness. The die tool can be configured to accommodate specific profiles, including variations in thickness of the thermoplastic and/or rubberized materials. In this manner, an effective sealing feature is combined with an acceptable amount of elasticity. The multi-layer composite structure 26 is preferably configured as a flat sheet or may be formed into simple or complex shapes. The multi-layer composite structure 26 may be used to make, for example, covers, enclosures, wrappers, sleeves, hoods, and spheres, including, for example, the applications described below in connection with FIGS. 4 through 10.

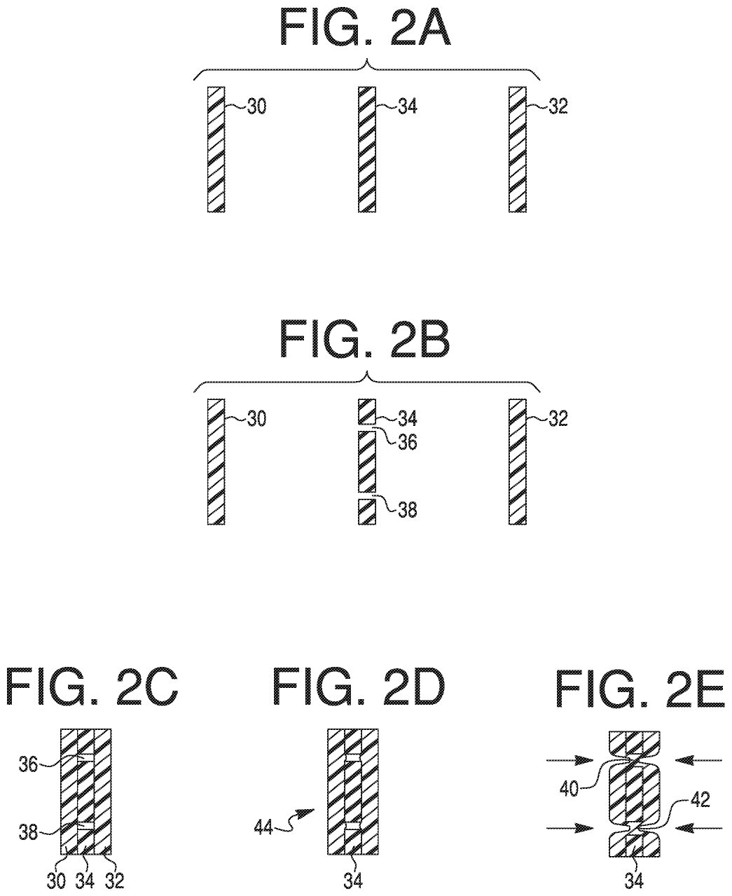

Another exemplary embodiment of the present invention is shown in FIGS. 2A through 2E. This second embodiment uses the physical properties of thermoplastic materials that make the materials pliable or moldable above a specific temperature and solidify upon cooling.

FIG. 2A shows a cross section of first and second planar thermoplastic layers or sheets 30 and 32. The thermoplastic layers 30 and 32 may be made of, for example, polyvinyl chloride, polyethylene, polypropylene, polyurethane, polycarbonate, polystyrene, polybenzimidazole, acrylics, acrylonitrile-butadiene-styrene (ABS), polyamides (e.g., Nylons), and polytetrafluoroethylene (e.g., Teflon®), and combinations, copolymers, and terpolymers thereof. The thermoplastic materials of thermoplastic layers 30 and 32 may be the same as or different than one another. An elastomeric layer 34, also depicted in cross section, may be made of, for example, a natural or synthetic rubber, such as silicone rubber, neoprene, or ethylene-propylene-diene monomer (EPDM), or combination thereof. The elastomeric material preferably is suitable for forming a seal.

FIG. 2B depicts the elastomeric layer 34 in cross section with perforations 36 and 38 passing therethrough. Although two perforations 36 and 38 are shown in FIGS. 2B through 2E, it should be understood that a single perforation may be provided in the elastomeric layer 34. Alternatively, two, three, four, five, or more perforations may be formed in the elastomeric layer 34. The perforations 36 and 38 may be of a constant diameter, as shown, or may taper. The perforations 36 and 38 may have identical or different dimensions and shapes relative to one another. For example, the perforations 36 and 38 may be circular, polygonal, oval, slit-shaped, etc. Formation of the perforations 36 and 38 in the elastomeric layer 34 may be accomplished by, for example, the techniques described above in connection with the description of FIG. 1B and the formation of perforations 14 and 16.

FIG. 2C is a cross-sectional view of the thermoplastic layers 30 and 32 on either side of the elastomeric layer 34 and abutting the opposite surfaces of the elastomeric layer 34 in direct surface-to-surface contact with no intermediate material(s) interposed therebetween. An external source or sources of heat and pressure (e.g., mold dies) are applied to the thermoplastic layers 30 and 32 for an adequate amount of time to allow the thermoplastic layers 30 and 32 to at least partially melt and flow into the perforations 36 and 38 of the elastomeric layer 34. The applied temperature is preferably not so high as to degrade the elastomeric layer 34. Suitable temperatures and pressures will depend upon the particular thermoplastic material or materials selected, but the temperatures desirably are at or above the melting temperature of the thermoplastic material(s). Desirably, the pressure is sufficiently high so that the at least partially melted thermoplastic material flows into the opposite ends of the perforations 36 and 38 from thermoplastic layers 30 and 32 to meld together. FIG. 2D shows the thermoplastic material beginning to flow into the perforations. Interconnecting portions 40 and 42 of the thermoplastic material extend through the perforations 36 and 38 to integrally connect the thermoplastic layers 30 and 32 to one another as pressure is applied, as shown in FIG. 2E, in which the arrows represent the application of pressure.

The thermoplastic material is then cooled below its melting temperature so that the interconnecting portions 40 and 42 of the thermoplastic material in the perforations 36 and 38, respectively, interlock the thermoplastic layers 30 and 32 together on the opposite surfaces of the elastomeric layer 34. The thermoplastic layers 30 and 32 and the interconnecting portions 40 and 42 are formed integrally with one another, such that the thermoplastic layers 30 and 32 and the interconnecting portions 40 and 42 are a single piece (monolithic) with no mechanical fasteners or adhesive. The pressure source may be removed prior to, during, or after cooling of the thermoplastic material. Collectively, the thermoplastic layers 30 and 32 and the elastomeric layer 34 provide a multi-layer (three-layer in FIG. 2E) composite structure 44. This method creates a mechanical bond. The thermoplastic layers are subjected to pressure and heat on both sides of the perforation. The elastomeric layers compress under the force of the pressure used to push the thermoplastic layers through the perforations. Preferably, the method and structure of the second embodiment of the invention provide extended strength and reliability and overcome some, if not all, of the problems and difficulties of the background art.

Different heat-generating processes may be used in fabricating and assembling devices from thermoplastic films in accordance with this and other embodiments described herein. These processes include radio frequency (RF) welding, ultrasonic welding, direct thermal sealing, impulse sealing, hot-plate welding, and induction welding. In each welding process, controlled heat is applied to the materials, causing the thermoplastic to melt in a narrow zone at the joint interface. Pressure is applied and, once the heat is removed, the thermoplastic material cools and re-solidifies, forming a weld bond. A smooth, uniform bead along the weld line is particularly desirable.

The RF welding process generates radio-wave power, which produces enough heat to melt thermoplastic materials and produce a free exchange of molecules, thereby bonding materials. Although dielectric heating can be performed at frequencies ranging from 10 to 100 MHz, the radio frequency most commonly used in the United States is 27.12 MHz. The process offers consistent quality, thin weld lines, short sealing cycles for high output, minimal thermal distortion of the film or substrate, and the ability to produce weld-edge tear seals. RF welding may be used as a heat-generating process to join flexible PVC and polyurethane film. Materials such as polyethylene, polypropylene, polystyrene, silicone, and rubber are less responsive or unresponsive to the RF welding process. A die, machined in the shape of the part to be welded, is often used to apply power to the thermoplastic workpiece. The die is pressed against the part, and a high-intensity alternating field is directed through the material, the material heats and the material melts upon exceeding its melting point. When the power to the RF-energy generator is shut off, the melted thermoplastic cools and re-solidifies, resulting in a uniform weld that is as strong as or stronger than the materials being bonded together. The entire process can take from a fraction of a second to several seconds, depending on the polymer, film thickness, and size of the welding zone. Tooling for the RF welding process may include an upper die mounted to an aluminum tool and jig plate and a bottom die or nest, typically made of aluminum. However, any metal that conducts electricity will work.

Ultrasonic welding sends vibrations through thermoplastic workpieces. The heat required to melt the workpieces is generated by the mechanical movement. The heat causes the workpieces to melt at the interface and form a bond. Electrical energy is transformed into high-frequency (20 to 40 kHz) vibrations, which are directed into the thermoplastic workpieces in a holding fixture through an ultrasonic fixture. The melted thermoplastic workpieces are pressed together and held until cooled. Soft thermoplastics can be difficult to bond with this process.

Direct thermal sealing methods are well suited for joining soft thermoplastics such as polypropylene, polyethylene, and thermoplastic polyimides. In hot-tool welding, one or more electrically heated platens or bars are pressed against the surfaces of the films until they melt or soften and bond together at the point of contact to form a weld. Equipment for carrying out the hot-tool welding may include one or two electrically heated bars, one of which is hinged for the insertion and removal of the films. A nonstick coating, such as polytetrafluoroethylene, on the tool facilitates removal of the joined materials. Platens for temperatures up to 260° C. (500° F.) may be made of aluminum. For higher temperatures, bronze and steel maybe used. Cycle time is typically less than 20 seconds. Using heated platens on each side of the parts can reduce the welding time of a thermoplastic to 1-3 seconds. Since heat is desirably conducted to the joint interface, the thickness of the materials being welded is a consideration. Thickness is generally about 1 mm.

Impulse sealing is a form of hot-tool welding in which the heating and cooling cycles are controlled while the joint is held under pressure. Impulse-type sealers use a metal wire or bar that is heated intermittently to avoid overheating the thermoplastic material. Impulse welding and hot-bar sealing produce a seal area that is, for example, about ⅛ in. wide.

Hot-plate welding is a variation of direct thermal sealing. The layers of thermoplastic film to be joined are held in fixtures, which press the layers against either side of a heated platen. Once the layers are sufficiently molten, the platen is removed. The layers are pressed together and held in the pressed state until the layers have cooled, forming a molecular bond. Most thin thermoplastic films can be welded with this process.

Induction welding is a technique that uses electromagnetism. The required heat is generated by an induction field. An electric current is passed through a work coil placed close to the joint. This heats an implant and the surrounding thermoplastic softens and melts. If pressure is applied to the joint, a weld forms as the joint cools.

As modifications to the embodiment of FIGS. 2A through 2E, the multi-layer structure 44 may include two or more thermoplastic layers 30 and 32 on one or both sides of the elastomeric layer 34. The elastomeric layer 34 can be replaced with two or more adjacent elastomeric layers. Multiple thermoplastic layers and elastomeric layers may alternate with one another, e.g., a thermoplastic/elastomeric/thermoplastic/elastomeric/thermoplastic structure. Any one or more of the thermoplastic and elastomeric layers 30, 32, and 34 may be planar, non-planar, uniform in thickness, or non-uniform in thickness. The multi-layer structure 44 preferably is configured as a flat sheet or as a more complex shape. The multi-layer structure 44 may be used to make, for example, covers, enclosures, wrappers, sleeves, head coverings, hoods, tubes, and spheres, including, for example, the applications described below in connection with FIGS. 4 through 10.

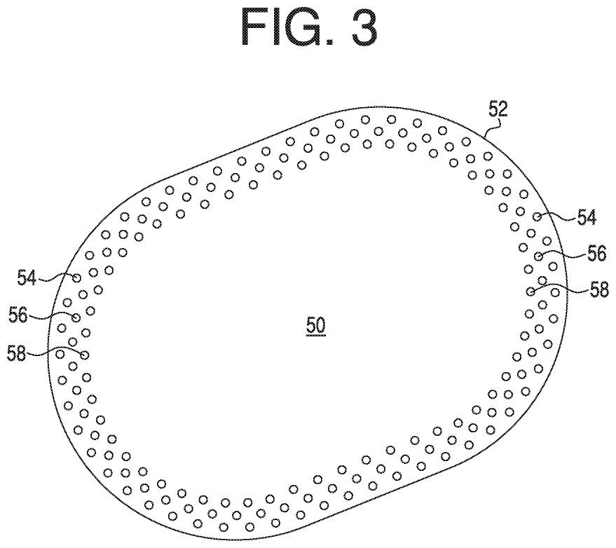

Referring now more particularly to FIG. 3, an elastomeric layer or sheet 50 is illustrated that may be used to implement the methods of FIGS. 1A through 1D and 2A through 2E. The elastomeric layer 50 includes an outer periphery 52 that has a generally circular shape, but may have a different shape, such as polygonal, oval, random, etc. The elastomeric layer 50 includes an outer ring of perforations 54 proximate to the outer periphery 52, an intermediate ring of perforations 56 inside the outer ring 54, and an inner ring of perforations 58 positioned inside the intermediate ring 56 so that the intermediate ring of perforations 56 is concentrically interposed between the inner and outer rings of perforations 54 and 58.

The elastomeric layer 50 of the embodiment of FIG. 3 may be made of a natural or synthetic rubber, such as silicone rubber, and may be used as the thermoplastic layers, e.g., layers 10, 30, and 32 in the manner described above in connection with FIGS. 1A through 1D and 2A through 2E. Although three rings of perforations 54, 56, and 58 are shown in FIG. 3, it should be understood that the elastomeric layer 50 may include one, two, three, four, or more rings of perforations. The perforations 54, 56, 58 may be provided in different (not ring-like or concentric) arrangements, such as in rows, arrays, or other ordered or random arrangements. The perforations 54, 56, and 58 may be of a constant diameter or may taper across the thickness of the elastomeric layer 50. The perforations 54, 56, and 58 may have identical or different spacing, dimensions and shapes relative to one another. For example, the perforations 54, 56, and 58 may be circular, polygonal, oval, slit-shaped, etc.

Formation of the perforations 54, 56, and 58 in the elastomeric layer 50 may be accomplished using, for example, the techniques described above in connection with FIGS. 1B and 2B with respect to the formation of perforations 14, 16, 36, and 38.

The elastomeric layer 50 may be joined to one or more thermoplastic films or sheets, such as polyvinyl chloride, polyethylene and/or polyurethane, through the application of heat and pressure, for example, in the manner described above in connection with FIGS. 1A through 1D and 2A through 2E, with elastomeric layer 50 providing layer 12 or 34. As described above, the source of heat and pressure is subsequently removed to solidify the thermoplastic film(s) or elastomeric sheet(s). This embodiment is particularly useful in connection with hoods, which are described in greater detail below. Due to the close proximity of the plurality of perforations and the precise geometry of those perforations arrayed in a fashion to accommodate the configuration of the design and placed to maximize the compression of the elastomer, a seal is created that is not easily negotiated by atmospheres, vapors, gases or particulates under the low negative pressure differential encountered in the hood that incorporates this element. The design allows the elastomeric member to move along the plane in a manner that is less restricted than is the case when rigid bonding methods are utilized.

Optionally but desirably, the joining of thermoplastics to elastomers in each of the above-described embodiments is performed without the use mechanical fasteners and/or adhesives.

Additional exemplary embodiments of the invention are directed to articles, such as, for example, covers, enclosures, wrappers, seals, sleeves, head coverings, hoods, and tubes that comprise one or more elastomeric layers with at least one perforation and one or more thermoplastic layers having at least one integral interconnection portion passing through the at least one perforation to join the elastomeric and thermoplastic layers to one another, preferably without the use of mechanical fasteners or adhesives.

FIG. 4 is a perspective view of a flexible protective cover 60 comprising a thermoplastic layer or layers having a generally spherical shape. The cover 60 surrounds and encases an object 62. The object 62 has a stem or stand 64 extending below it and supporting the object 62. An elastomeric layer 66 shaped as a collar or dam having one or more perforations (not shown in FIG. 4 but described above in connection with FIGS. 1A-1D, 2A-2E, and 3) and joined to the thermoplastic cover 60 in the manner described herein is provided at the base of the cover 60 around the stem 64. The elastomeric material of layer 66 is preferably sufficiently elastic to be spread over the object 62, yet has memory so that after being stretched and released, the elastomeric layer 66 returns to its original dimensions and shape. The elastomeric layer 66 is configured to form a tight, and even hermetic, seal about the stem 64 to protect the object 62 against contaminants and the outside environment. The object 62, depicted as a box for simplification and illustrative purposes in FIG. 4, may be an animate or inanimate object.

FIG. 5 is a perspective view of a flexible sleeve 70 including a thermoplastic layer or layers having a generally tubular shape with opposite open ends. An object, in particular a human arm 72, is located in and extends through the open ends of the flexible sleeve 70. A first elastomeric layer 74 and a second elastomeric layer 76 having one or more perforations (not shown in FIG. 5) and joined to the open ends of the flexible sleeve 70 in the manner described in FIG. 1A-1D or 2A-2E. The first and second elastomeric layers 74 and 76 may be made of one or more elastomeric materials suitable for expanding to receive the arm 72 while having memory so that after being stretched and released, the layers 74 and 76 return to their original dimensions and shape. The elastomeric layers 74 and 76 can be designed to form a tight, and even hermetic, seal about the arm 72 to protect the arm 72 against contaminants and isolate it from the outside environment. It should be understood that the object 72 may alternatively be a leg, another body part (e.g., neck), or an inanimate object.

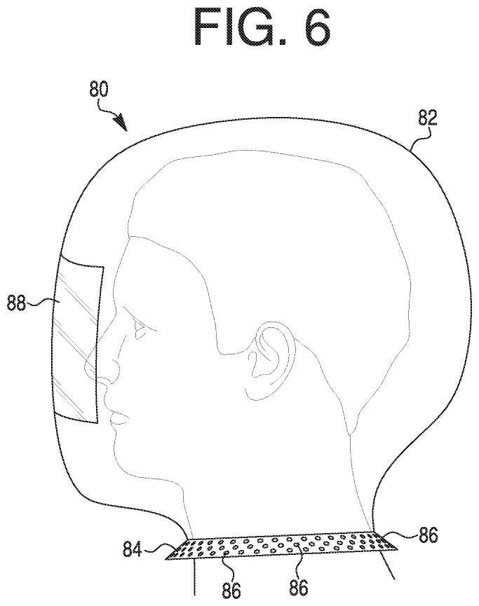

FIGS. 6 through 8 illustrate exemplary embodiments of hoods including a head covering made from a thin thermoplastic film or sheet (e.g., polyvinyl chloride, polyethylene, polyurethane, or combinations thereof) and a collar or dam made of an elastomeric material such as a natural or synthetic rubber (e.g., silicone rubber, neoprene, or ethylene-propylene-diene monomer (EPDM) rubber, or combinations thereof).

FIG. 6 is a side view of a hood 80 including a thermoplastic head covering 82 and an elastomeric neck collar/dam 84 having perforations 86 and arranged generally horizontally when fitted about the neck. The head covering 82 includes a transparent visor 88 providing a field of vision to allow the user to see outside of the head covering 82. The visor 88 may be made of a plastic material, such as polycarbonate, that may be welded (e.g., radiofrequency (RF) or high frequency welding) to the hood 82. The elastomeric neck collar 84 is expansive to fit over and receive the user's head, while having memory to return to its original dimensions and shape after being released. The elastomeric layer 84 is configured to form a tight, and even hermetic, seal about the neck to protect the head against contaminants and isolate it from the outside environment. Suitable methods for joining the thermoplastic head covering 82 and the elastomeric neck collar 84 are described above in connection with FIGS. 1A through 1D and FIGS. 2A through 2E.

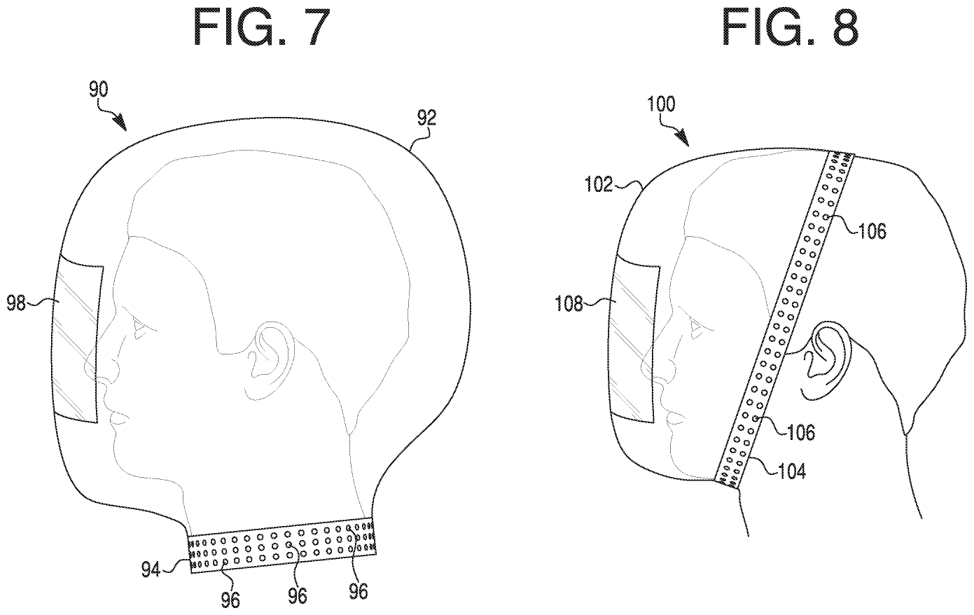

FIG. 7 is a side view of another hood assembly 90 including a thermoplastic head covering 92 and an elastomeric neck collar (or dam) 94 having perforations 96 and generally vertically arranged when fitted about the neck. The head covering 92 includes a transparent visor 98 that may be attached to the head covering 92 in the same manner as described above with respect to the head covering 82 and the visor 88. The elastomeric neck collar 94 is expansive to fit over and receive the user's head, while having memory to return to its original dimensions and shape after being released. The elastomeric layer 94 is configured to form a tight, and even hermetic, seal about the neck to protect the head against contaminants and isolate it from the outside environment. Suitable methods for joining the thermoplastic head covering 92 and the elastomeric neck collar 94 are described above in connection with FIGS. 1A through 1D and FIGS. 2A through 2E.

Various modifications to the embodiments of FIGS. 6 and 7 fall within the scope of the invention. For example, the neck collar 84 or 94 may be angled in any convenient and effective arrangement between the horizontal arrangement of the neck collar 84 of FIG. 6 and the vertical arrangement of the neck collar 94 of FIG. 7.

FIG. 8 is a side view of a partial hood assembly 100 including a thermoplastic head covering 102 and an elastomeric head collar (or dam) 104 having perforations 106. The head collar 104 fits under the chin and over the top of the user's head to protect the face and the forehead of the user. The head covering 102 includes a transparent visor 108 that may be attached to the head covering 102 in the same manner as described above with respect to the head covering 82 and the visor 88. The elastomeric head collar 104 is expansive to fit over and receive on the user's head. The elastomeric layer 104 is configured to form a tight, and even hermetic, seal about the head to protect the front of the head against contaminants and isolate it from the outside environment. Suitable methods for joining the thermoplastic head covering 102 and the elastomeric neck collar 104 are described above in connection with FIGS. 1A through 1D and FIGS. 2A through 2E.

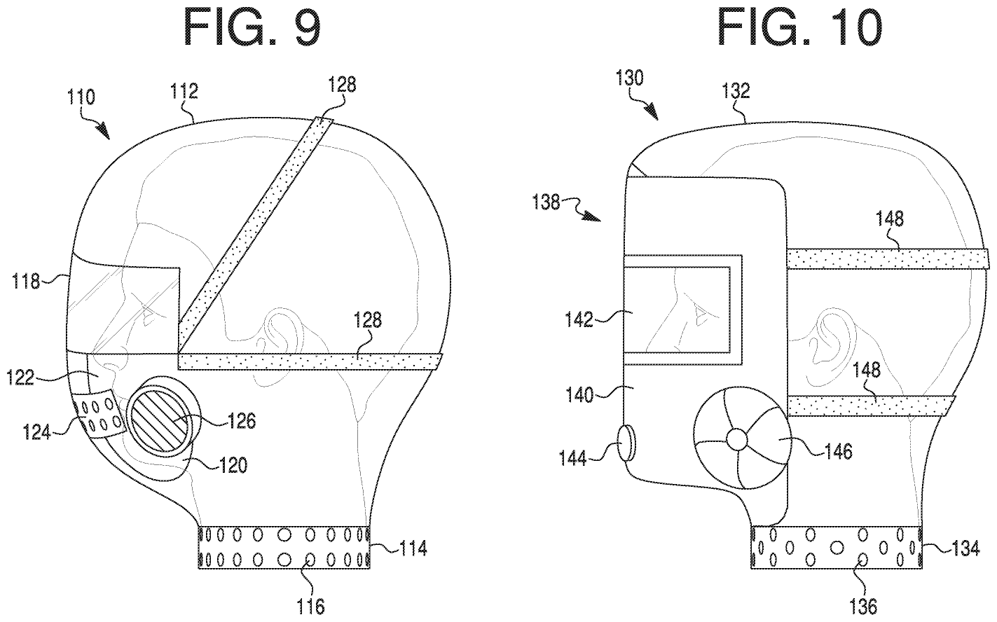

Additional embodiments of the invention will now be discussed with reference to FIGS. 9 and 10, which illustrate hoods incorporating respirators.

Generally, respirators protect users against environments and atmospheres containing airborne particulates, harmful dusts, fogs, smokes, mists, fumes, gases, vapors, and/or sprays. These hazards may be benign, or in some cases may cause cancer, lung impairment, diseases, or death. The use of respirators for occupational protection is generally subject to government regulations, such as those of the Occupational Safety and Health Agency (OSHA) in the United States.

There are two general main categories of respirators, each of which has its own manner of protecting the user. The first category is known as air-purifying respirators that remove contaminants and airborne particles from the surrounding air, which is then breathed by the user. Air-purifying respirators typically include cartridges or canisters for filtering vapors and gases. The second category is known as atmosphere-providing respirators that protect the user by supplying clean respirable air source other than the surrounding atmosphere when the surrounding atmosphere is unsuitable for breathing or does not contain adequate levels of oxygen or both. Respirators that fall into this category include airline respirators, which deliver breathing air from a remote source through hoses, and self-contained breathing apparatuses (SCBAs), which include their own air supply in portable cylinders. The principles of the present invention apply to both categories of respirators.

Respirators also can be classified as tight fitting and loose fitting, according to the type of face covering that is used. As used herein, tight fitting and loose fitting refer to the seal the respirator makes around the nose and mouth. Typically, a loose-fitting respirator is part of a system that includes a pressurized cylinder, an air compressor, and/or a battery-powered blower for delivering air into the hood. The principles of the present invention apply to both types of seals.

Typically, a tight-fitting respirator has a port over the mouth that receives a valve for inhalation and exhalation. The respirator also includes ports for fitting filters and cartridges, as shown in FIGS. 9 and 10, discussed below. In the case of a full facemask respirator, a see-through visor is also provided. A full facemask typically covers the wearer's face from chin (or below) to forehead (or above). Many full facemasks have an inner nose cup that fits over the wearer's nose and chin, covering the wearer's mouth. A half-mask covers the wearer's chin, nose and mouth, but typically not the wearer's eyes and forehead.

A respirator with a tight-fitting mask also has straps or a harness to secure the mask to the wearer's head, and tabs and buckles are provided to tighten the straps or the head harness around the user's head. Sealing surfaces are positioned around the perimeter of the respirator to tightly fit against the wearer's head or face. A head harness with straps and tabs that are rubberized or elasticized can be adjusted to obtain an adequate seal the wearer's head or face.

The use of respirators with tight-fitting masks to protect against toxic or unpleasant atmospheres is common practice. Typical applications include protection against toxic industrial materials including occupational hazards such as asbestos, volatile organic compounds, isocyanates and other materials. Respirators with tight-fitting masks are also used to protect against chemical agents such as nerve gas and against biohazards such as tuberculosis and bird flu. Such respirators are also used by members of the armed services, firefighters, and emergency responders. Respirators are also used by members of the public as protection against paints and substances used in household maintenance and cleaning. Respirators are also used during escape from a fire or an emergency caused by an accident or by a hostile incident.

In many of these applications it is desirable to add extra protection for the wearer by using a hood in addition to the tight-fitting half-mask or full face mask. The extra protection provided by the hood may be essential in situations where the hazard extends beyond inhalation of contaminated air. The respirators will provide a level of protection only against substances that affect people through the respiratory system and will not protect against injury to other parts of the head and body that are not covered by the respirator. For example, health care workers may need to be protected against splatter and splashing of biological hazardous materials that impact parts of the body exposed even while wearing a full face mask respirator with a tight-fitting respirator. Firefighters need protection from flames and dripping molten and flammable materials, as do people who are escaping from fires and other accidents or terrorist incidents. Some chemical agents and industrial toxic materials attack through the skin and so the wearer's head and neck, and optionally other body parts (e.g., shoulders) should be covered.

When a hood is used in conjunction with a respirator that has a tight fitting mask, the wearer's head will receive added protection in addition to that provided by the respirator. The amount of protection provided to the wearer depends on two factors. First, the tight-fitting respirator should be effective against the hazard present in the atmosphere. Second, the hood should fit tightly against the respirator and against the wearer at the head covering opening so that contaminated air does not leak through gaps and expose the wearer to hazards present in the atmosphere. Any gap between the hood and wearer's body at the head covering opening will reduce the protection experienced by the wearer, and can render the combination of hood and tight-fitting mask less effective and expose the wearer to greater risk of harm.

FIG. 9 is a side view of a hood 110 incorporating a respirator. The hood 110 includes a head covering 112 that fits over the user's head. The head covering 112 is made of a thermoplastic material, such as polyvinyl chloride, polyethylene, polypropylene, polyurethane, polycarbonate, polystyrene, polybenzimidazole, acrylics, acrylonitrile-butadiene-styrene (ABS), polyamides (e.g., Nylons), and polytetrafluoroethylene (e.g., Teflon®), and combinations, copolymers, and terpolymers thereof. A neck collar (or dam) 114 has a generally vertical arrangement, although it may be modified to have the horizontal arrangement shown in FIG. 6. The neck collar 114 may be made of an elastomeric material, such as natural or synthetic rubber, to form a seal around the wearer's neck. Perforations 116 are formed in the neck collar 114. The hood 110 further includes a transparent visor 118 for providing a field of vision to allow the user to see outside of the head covering 112. A respiratory unit 120 is incorporated into the hood 110. The respiratory unit 120 in FIG. 9 includes an integrated nose cup or half mask 122, an exhalation valve 124, and filtering elements 126 extending from opposite sides of the half mask 122. Straps 128 (or a harness) that connect to the half mask 122 are located outside of the head covering 112 and extend around the user's head to hold the respirator unit 120 in place. The exhalation valve 124 and the filtering elements 126 protrude through ports in the head covering 112. The visor 118, the exhalation valve 124, and the filtering elements 126 may be made of plastic materials that may be welded (e.g., radiofrequency (RF) or high frequency welding) to the head covering 112. The hood 110 can be positioned over the user's head without obstructing the inhalation or exhalation of air through the half mask 122.

FIG. 10 is a side view of a hood 130 incorporating a full mask respirator. The hood 130 includes a head covering 132 that fits over the user's head. The head covering 132 is made of a thermoplastic material, such as polyvinyl chloride, polyethylene, polypropylene, polyurethane, polycarbonate, polystyrene, polybenzimidazole, acrylics, acrylonitrile-butadiene-styrene (ABS), polyamides (e.g., Nylons), and polytetrafluoroethylene (e.g., Teflon®), and combinations, copolymers, and terpolymers thereof. A neck collar (or dam) 134 has a generally vertical arrangement, although it may be modified to have the horizontal arrangement shown in FIG. 6. The neck dam 134 may be made of an elastomeric material, such as natural or synthetic rubber, to form a seal around the wearer's neck. Perforations 136 are formed in the neck dam 134. A respiratory unit 138 is incorporated into the hood 130. The respiratory unit 138 includes a full face mask 140 with a transparent visor 142, an exhalation valve 144 in the mask 140, and filter elements 146 extending from opposite sides of the mask 140. Straps (or a harness) 148 that connect to the mask 140 are located outside of the head covering 132 and extend around the user's head to hold the respirator unit 138 in place. The mask 140 may be made of a plastic material that may be welded (e.g., radiofrequency (RF) or high frequency welding) to the head covering 132. The hood 130 can be positioned over the user's head without obstructing the inhalation or exhalation of air through the full mask 140.

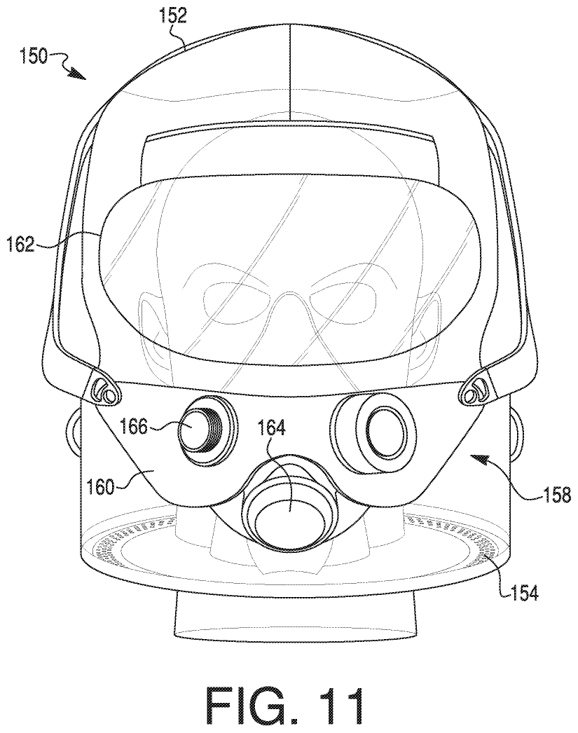

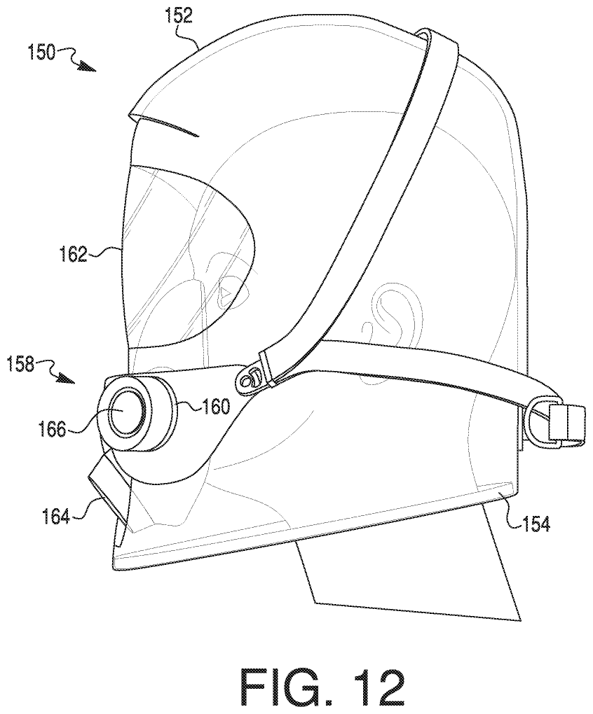

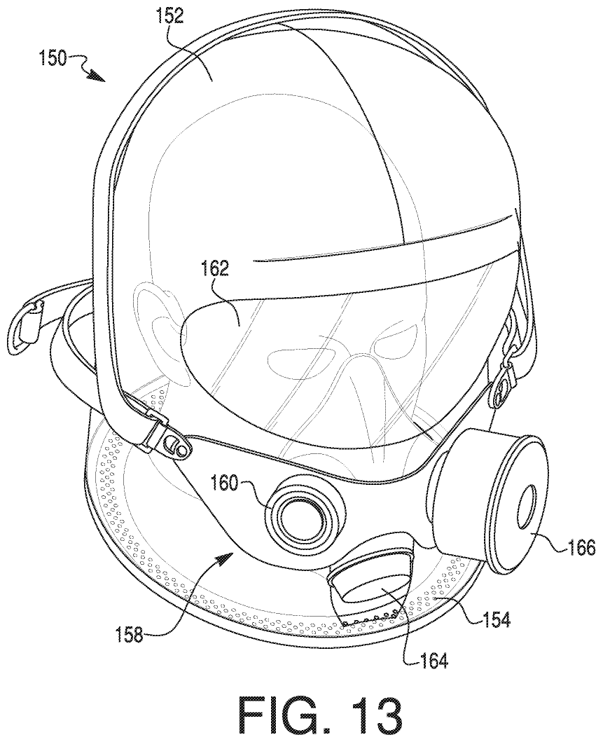

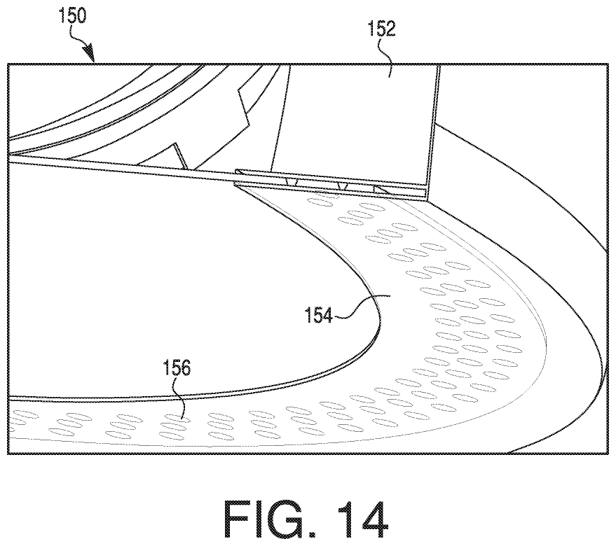

FIGS. 11-14 are views of a hood 150 incorporating a full mask respirator. The hood 150 includes a head covering 152 that fits over the user's head. The head covering 152 is made of a thermoplastic material, such as polyvinyl chloride, polyethylene, polypropylene, polyurethane, polycarbonate, polystyrene, polybenzimidazole, acrylics, acrylonitrile-butadiene-styrene (ABS), polyamides (e.g., Nylons), and polytetrafluoroethylene (e.g., Teflon®), and combinations, copolymers, and terpolymers thereof. A neck collar (or dam) 154 has a generally horizontal arrangement, although it may be modified to have the vertical arrangement shown in FIGS. 9 and 10. The neck dam 154 may be made of an elastomeric material, such as natural or synthetic rubber, to form a seal around the wearer's neck. Perforations 156 (see FIG. 14) are formed in the neck dam 154. A respiratory unit 158 is incorporated into the hood 150. The respiratory unit 158 includes a mask 160, a transparent visor 162, an exhalation valve 164, and filter elements 166 extending from opposite sides of the mask 160. Straps (or a harness) 168 that connect to the mask 160 are located outside of the head covering 152 and extend around the user's head to hold the respirator unit 158 in place. The mask 160 may be made of a plastic material that may be welded (e.g., radiofrequency (RF) or high frequency welding) to the head covering 152. The hood 150 can be positioned over the user's head without obstructing the inhalation or exhalation of air through the full mask 160.

In FIGS. 9-14, the thin thermoplastic film or sheet of the head covering 112 or 132 or 152 is joined to the elastomeric material of the neck collar 114 or 134 or 154 by bringing the materials together and applying heat and pressure to at least partially melt the thermoplastic material so that the thermoplastic material passes into the perforations 116 or 136 or 156 contained in the elastomer. Suitable methods include those described above in connection with FIGS. 1A through 1D and FIGS. 2A through 2E. Heat is then removed to allow the thermoplastic to solidify. The pressure may be removed before, during, or after the heat is removed.

The principles of the present invention apply to respiratory units having different combinations of filters, cartridges, inhalation ports, exhalation ports and other features of half-masks and full-face masks. The principles of the present invention may also be applied to atmosphere-providing respirators. For example, the hood assembly may include an opening for connection to a breathing tube that extends to an air or oxygen supply, compressor, air pump, battery-powered blower, etc. The visors (e.g., 88, 98, 108, 118, 142 and 162) may include an anti-fog coating or laminate.

Exemplary embodiments of the invention attach a hood to a respirator without affecting the form, fit or function of the respirator. The hood is manufactured from a thin thermoplastic film or sheet such as polyvinyl chloride, polyethylene or polyurethane and a neck dam forming a seal around the wearer's neck. The neck collar is manufactured from an elastomeric material such as rubber or synthetic rubber and is securely attached to the hood material to reduce or eliminate the possibility of leakage. The need for wearers to accept the lower protection provided by a loose-fitting hood respirator is thus avoided.

The embodiments exemplified herein can be incorporated into a protective hood for use with various types of health and safety respirators and related equipment capable of satisfying test and certification requirements of applicable approval and certification standards and regulations, in particular those of the National Institute for Occupational Safety and Health (NIOSH) as set forth in Title 42 of the Code of Federal Regulations (CFR) (2018), Sections 84 et seq., including Sections 84.71 and 84.99-84.104 for self-contained breathing apparatus; Sections 84.111, 84.118, 84.119, and 84.124 for gas masks; Sections 84.131, 84.135, 84.136, 84.159, and 84.162 for supplied-air respirators; Sections 84.171, 84.175, and 84.176 for non-powered air-purifying particulate respirators; Sections 84.198, 84.199, and 84.205 for chemical cartridge respirators; and Sections 84.1131, 84.1135, 84.1136, 84.1141, and 84.1142 for dust, fume, and mist, pesticide, paint spray, powered air-purifying high efficiency respirators and combination as masks.

The various components, features, and steps of the above-described exemplary embodiments may be substituted into one another in any combination. It is within the scope of the invention to make the modifications necessary or desirable to incorporate one or more components, features, and/or steps of any one embodiment into any other embodiment. In addition, although the exemplary embodiments discuss steps performed in a particular order for purposes of illustration and discussion, the methods discussed herein are not limited to any particular order or arrangement. One skilled in the art, using the disclosures provided herein, will appreciate that various steps of the methods can be omitted, rearranged, combined, supplemented, and/or adapted in various ways.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to necessarily limit the invention to the precise embodiments disclosed.

What is claimed is:

1. A hood, comprising:
a collar comprising at least one elastomeric layer configured to be sealingly fit around a body part of a wearer, the at least one elastomeric layer having a plurality of perforations; and
a head covering comprising at least one thermoplastic layer configured to receive a head of the wearer, the head covering further including a plurality of integral thermoplastic connections extending through the perforations of the elastomeric layer to seal the head covering to the collar.

2. The hood of claim 1, wherein the integral thermoplastic connections are formed by at least partially melting the thermoplastic layer, causing the at least partially melted thermoplastic layer to flow into the perforations of the collar, and solidifying the thermoplastic layer.

3. The hood of claim 1, wherein the collar is configured to fit around a neck of a wearer.

4. The hood of claim 1, wherein the elastomeric layer comprises a first surface in contact with the thermoplastic layer and an opposite second surface, and wherein the integral thermoplastic connections comprise integral head portions in contact with the opposite second surface of the elastomeric layer.

5. The hood of claim 4, wherein the head portions are larger in width than the perforations.

6. The hood of claim 1, wherein the at least one thermoplastic layer comprises first and second thermoplastic layers arranged on opposite surfaces of the elastomeric layer, the integral thermoplastic connections being formed with the first and second thermoplastic layers by at least partially melting the first and second thermoplastic layers to join with one another through the perforations.

7. The hood of claim 1, further comprising a respirator operatively associated with the head covering.

8. The hood of claim 7, wherein the respirator comprises a half-mask.

9. The hood of claim 7, wherein the respirator comprises a full mask.

10. A containment assembly, comprising:
a collar comprising at least one elastomeric layer, the at least one elastomeric layer comprising a plurality of perforations; and
a covering comprising at least one thermoplastic layer, a plurality of integral thermoplastic connections extending through the perforations of the elastomeric layer to seal the covering to the collar.

11. The containment assembly of claim 10, wherein the integral thermoplastic connections are circumferentially arrayed about the thermoplastic layer.

12. The containment assembly of claim 10, wherein the elastomeric layer comprises a first surface in contact with the thermoplastic layer and an opposite second surface, and wherein the integral connections comprise integral head portions in contact with the opposite second surface of the elastomeric layer.

13. The containment assembly of claim 12, wherein the head portions are larger in width than the perforations.

14. The containment assembly of claim 10, wherein the at least one thermoplastic layer comprises first and second thermoplastic layers arranged on opposite surfaces of the elastomeric layer, the integral connections being formed with the first and second thermoplastic layers by at least partially melting the first and second thermoplastic layers to join with one another through the perforations.

15. The containment assembly of claim 10, further comprising:
an additional collar comprising at least one additional elastomeric layer configured to be sealingly fit around the body part of a wearer, the additional collar comprising additional perforations,
wherein the covering comprises a tubular covering and the at least one thermoplastic layer terminates at an additional edge portion defining an additional opening configured for insertion of the body part of the wearer, the covering further comprising additional integral connections extending through the additional perforations of the additional collar to sealingly engage the covering to the additional collar, the additional integral connections being integrally formed by bringing the thermoplastic layer and the additional elastomeric layer together, at least partially melting the thermoplastic layer, causing the at least partially melted thermoplastic layer to flow into the additional perforations of the additional collar, and solidifying the thermoplastic layer.

16. A method of joining together at least one thermoplastic layer and at least one elastomeric layer, comprising the steps of:
providing a plurality of perforations in at least one elastomeric layer;
juxtaposing the at least one thermoplastic layer and the at least one elastomeric layer;
at least partially melting the at least one thermoplastic layer so that the at least one thermoplastic layer flows into the perforations; and
solidifying the at least one thermoplastic layer so that connections integral with the at least one thermoplastic layer extend through the perforations.

17. The method of claim 16, wherein the at least one elastomeric layer comprises a first surface in contact with the at least thermoplastic layer and an opposite second surface, and wherein the integral connections comprise integral head portions in contact with the opposite second surface of the at least one elastomeric layer.

18. The method of claim 17, wherein the head portions are larger in width than the perforations.

19. The method of claim 16, wherein the at least one thermoplastic layer comprises first and second thermoplastic layers arranged on opposite surfaces of the elastomeric layer, the integral connections being integrally formed with the first and second thermoplastic layers by at least partially melting the first and second thermoplastic layers to join with one another through the perforations.

20. The method of claim 16, wherein the at least one elastomeric layer comprises a collar configured to sealingly fit around a body part of a wearer.
